(19) United States
(12) Patent Application Publication
(10) Pub. No.: US 2024/0177073 A1
(43) Pub. Date: May 30, 2024

(54) SYSTEMS AND METHODS FOR AUGMENTING SEARCH REQUESTS TO MITIGATE COMPUTATIONAL LOAD

(71) Applicant: AMADEUS S.A.S., Biot (FR)

(72) Inventors: Olivier AMADIEU, Roquefort les Pins (FR); Yannick DEVAUX, Mougins (FR); Jean-Marie CAZORLA, Opio (FR)

(21) Appl. No.: 18/059,692

(22) Filed: Nov. 29, 2022

(51) Int. Cl. G06Q 10/02; G06Q 30/06

(52) U.S. Cl. CPC G06Q 10/025; G06Q 30/0631

(57) ABSTRACT

A method in an aggregator includes: storing (i) previous search results generated by supplier subsystems, in response to previous search requests, and (ii) for each previous search result, an identifier of the supplier subsystem that generated the previous search result; receiving a current search request containing current search parameters; responsive to receiving the current search request, selecting a set of the supplier subsystems for search result generation; for a first supplier subsystem from the set, retrieving from storage a previous search result associated with a second supplier subsystem from the set, based on correspondence between the search parameters and attributes of the previous search results; and sending, to the first supplier subsystem, (i) the current search request, and (ii) auxiliary search parameters corresponding to the retrieved previous search result, for generation of current search results at the first provider subsystem employing the auxiliary search parameters as inputs.

### BACKGROUND

Certain computing systems perform functionality that involves receiving, processing, and responding to large volumes of requests (e.g., thousands of requests per hour). Responding to such requests can include generating datasets to return to requesting computing devices. Generating the return datasets can also be computationally complex, e.g., to a significantly greater degree than retrieving and returning previously stored and indexed search results.

### SUMMARY

An aspect of the specification provides a method, comprising: at an aggregator, storing a repository containing: (i) a plurality of previous search results generated by supplier subsystems, in response to previous search requests received at the supplier subsystems, and (ii) for each previous search result, a supplier identifier of the supplier subsystem having generated the previous search result; receiving a current search request containing current search parameters at the aggregator; responsive to receiving the current search request, selecting, at the aggregator, a set of the supplier subsystems for search result generation; for a first supplier subsystem from the set, retrieving a previous search result associated in the repository with a second supplier subsystem from the set, based on correspondence between (i) the search parameters and (ii) attributes of the previous search results; and sending, from the aggregator to the first supplier subsystem, (i) the current search request, and (ii) auxiliary search parameters corresponding to the retrieved previous search result, for generation of current search results at the first provider subsystem employing the auxiliary search parameters as inputs.

Another aspect of the specification provides a computing device, comprising: a memory storing a repository containing: (i) a plurality of previous search results generated by supplier subsystems, in response to previous search requests received at the supplier subsystems, and (ii) for each previous search result, a supplier identifier of the supplier subsystem having generated the previous search result; and a processor configured to: receive a current search request containing current search parameters at the aggregator; responsive to receiving the current search request, select a set of the supplier subsystems for search result generation; for a first supplier subsystem from the set, retrieve a previous search result associated in the repository with a second supplier subsystem from the set, based on correspondence between (i) the search parameters and (ii) attributes of the previous search results; and send, to the first supplier subsystem, (i) the current search request, and (ii) auxiliary search parameters corresponding to the retrieved previous search result, for generation of current search results at the first provider subsystem employing the auxiliary search parameters as inputs.

### BRIEF DESCRIPTIONS OF THE DRAWINGS

Embodiments are described with reference to the following figures, in which:

FIG. 1 is a diagram illustrating a system for enriching search requests.

FIG. 2 is a diagram illustrating certain internal components of the aggregator of FIG. 1.

FIG. 3 is a flowchart of a request handling method.

FIG. 4 is a diagram illustrating an example performance of block 305 of the method of FIG. 3.

FIG. 5 is a diagram illustrating an example performance of block 325 of the method of FIG. 3.

FIG. 6 is a diagram illustrating an example performance of block 335 of the method of FIG. 3

FIG. 7 is a diagram illustrating the generation of search results at a supplier subsystem of the system of FIG. 1.

FIG. 8 is a diagram illustrating another example performance of block 325 of the method of FIG. 3

### DETAILED DESCRIPTION

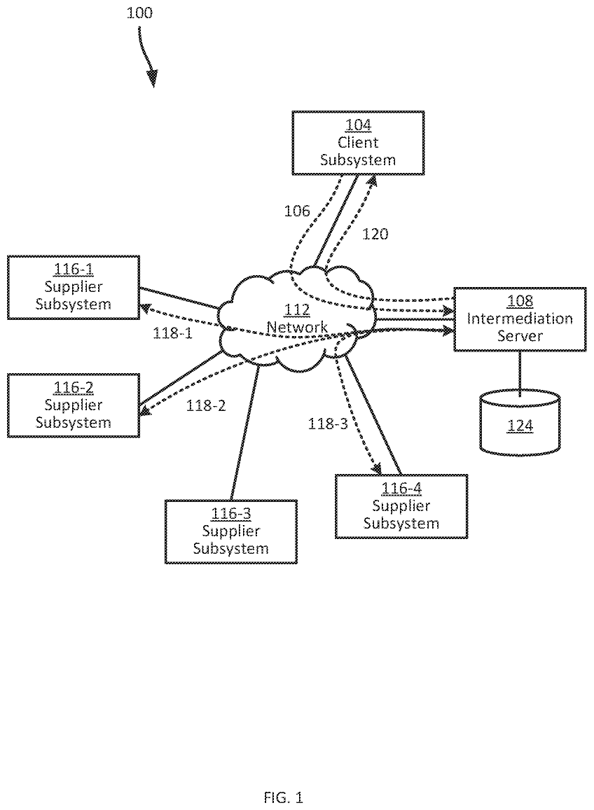

FIG. 1 illustrates a request-handling system 100. In general, the requests handled within the system 100 are generated at a client subsystem 104, and include a variety of search parameters. The client subsystem 104 includes at least one computing device, such as a desktop computer, a mobile computer, or the like. The client subsystem 104 can also include a server or set of servers implementing a software platform that enables the receipt of inputs from consumer-level devices (such as the above-mentioned desktop or mobile computer), for generating search requests. As will be apparent in the discussion below, the system 100 may include a plurality of distinct client subsystems 104, however a single client subsystem 104 is illustrated for simplicity.

A search request 106 generated by the client subsystem 104 is transmitted to an intermediation server 108 via a network 112 (e.g., any suitable combination of local and wide-area networks). The intermediation server 108, which can also be referred to as an aggregator 108, is implemented as a server, or a set of servers (e.g., implemented as a suitable distributed computing system). The aggregator 108, upon receiving the search request 106, distributes the search request among a set of supplier subsystems 116-1, 116-2, 116-3, and 116-4 (collectively referred to as the supplier subsystems 116, and generically referred to as a supplier subsystem 116; similar nomenclature may also be used for other components herein). The system 100 can include a smaller number of supplier subsystems 116, or a larger number of supplier subsystems 116, than shown in FIG. 1.

Each supplier subsystem 116 is implemented as a server or set of servers, and employs a wide variety of data processing mechanisms and stored data to generate search results corresponding to the search request. The supplier subsystems 116 are typically independent from one another (e.g., by operating entities in competition with one another), and may implement distinct processing mechanisms and have access to distinct sets of stored data used to generate search results.

Via a set of data exchanges 118-1, 118-2, and 118-4, the aggregator 108 transmits the search request 106 to the supplier subsystems 116-1, 116-2, and 116-4, and in return, receives search results from those supplier subsystems 116. As will be apparent, the request 106 was not provided to the supplier subsystem 116-3, as the intermediation server 108 need not select all the supplier subsystems 116 from which to solicit search results. Further, the aggregator 108 need not select the same set of supplier subsystems 116 for each request received from the client subsystem 104.

Having received search results from at least some of the supplier subsystems 116 (via the data exchanges 118), the aggregator 108 is configured to return a collected set of search results 120 to the client subsystem 104. Prior to returning the set of search results 120, the aggregator 108 can process the search results as received from the supplier subsystems 116, for example to select a subset of the search results, and discard the remainder. The proportion of search results discarded at the aggregator 108 for any given search request can be substantial, e.g., more than 70% in some cases. The search results 120, in other words, may represent only a fraction of the search results generated by the supplier subsystems 116.

The search request 106, and the generation of search results by the supplier subsystems 116, have certain characteristics that render the handling of the search request 106 computationally costly for at least certain components of the system 100. For example, the search results are generally not stored in a form in which they can be retrieved by the supplier subsystems 116 and returned to the aggregator 108 for delivery to the client subsystem 104. Instead, each supplier subsystem 116 generates each search result by retrieving or dynamically generating distinct elements of the search result, and determining combinations of such elements that are likely to accurately match the search parameters of the search request 106. The number of available elements, and therefore the number of potential combinations to be processed, may be large (e.g., a number of possible combinations numbering in the hundreds of millions).

Further, the identification by a given supplier subsystem 116 of which of the above-mentioned combinations is likely to be an accurate result corresponding to the search request 106 is generally uncertain. For example, although the search request 106 can include numerous search parameters, the search request 106 may nevertheless fail to completely describe the nature of the search results being sought by the originator of the search request (e.g., a customer operating the client subsystem 104). An incomplete description of the results sought by the originator of the search request 106 introduces ambiguity to the process of generating possible search results by the supplier subsystems 116, as well as to the process of selecting subsets of search results at the aggregator 108 to return to the client subsystem 104. Further, the selection of certain search results, and the discarding of other search results, by the aggregator 108 is generally an opaque process from the perspective of a supplier subsystem 116. Still further, as noted earlier the operators of the supplier subsystems 116 may be in competition with one another, and each supplier subsystem 116 may therefore have little visibility into which other supplier subsystems 116 are generating results for a given search request, and into the specific process by which those other supplier subsystems 116 generate search results.

Each supplier subsystem 116 can therefore be configured to generate a significant number of search results (e.g., tens or hundreds) to each search request 106. The search results generated by a given supplier subsystem 116 may, for example, represent a range of possible matches to the search request 106, with the expectation that at least a portion of that range will be selected by the aggregator 108 for return to the client subsystem 104 (and the further expectation that some of the results selected by the aggregator 108 will be selected at the client subsystem 104 for further processing such as purchasing, which may lead to revenue for the operating entity of the relevant supplier subsystem 116).

In other systems, each supplier subsystem 116 can attempt to increase the accuracy and/or relevance of its search results by implementing a two-staged process. In such a process, a supplier subsystem 116 can generate an initial set of search results, and seek feedback from the aggregator 108 as to which of that initial set would be passed to the client subsystem 104. Such feedback can be incorporated into a process at the supplier subsystem 116 to generate a final set of search results. The final set of search results, upon transmission to the aggregator 108, are processed at the aggregator 108 to select some, all, or none, for return to the client subsystem 104. As will be apparent, both of the above approaches (generating a large number of “guesses”, or generating a smaller number of guesses and then updating those guesses based on feedback) are costly in terms of computational resources. The above approaches also have longer response times as a result of the two distinct calls in sequence. Further, the above approaches may yield less relevant results, as they are dependent on historical results.

A further characteristic of the request handling process implemented in the system 100 is that the search results are generated substantially in real-time with the search request 106. That is, the time elapsed between submission of the search request 106 and delivery of the search results 120 is expected to be minimal (e.g., below about five seconds). Greater delays between an incoming search request 106 and outgoing search results 120 may lead to the client subsystem 104 abandoning the request, thus wasting any computational resources expended in generating responses. Generating the large variety of search results mentioned above at the supplier subsystems 116, and evaluating the search results to select the set of search results 120 at the aggregator 108, may therefore involve the deployment of substantial computing resources. As will also be apparent from the above discussion, much of the computational resources devoted to generating and transmitting search results will yield search results that are either discarded by the aggregator 108 (i.e., not returned to the client subsystem 104), or ignored (i.e., not selected for purchase or other further processing) at the client subsystem 104. Discarded and ignored search results derive little or no return (e.g., commercial return, when the search results represent products or services) from the expenditure of the computational resources mentioned above.

The system 100 therefore includes additional features that reduce the computational impact of handling search requests such as the request 106, while mitigating potential negative impacts on the accuracy of the search results that may arise from the reduction in computational impact. In some cases, the additional features may also improve the accuracy of the search results, while optimizing computational load.

Although the specific nature of the requests and responses discussed herein is not particularly limited, for the purpose of illustration, in the discussion below, the search requests 106 are requests for travel-related products and services (generally referred to as “items” below). Such products and services include, for example, airline tickets, hotel reservations, rental vehicle reservations, and the like. The client subsystem 104 may therefore be a computing device operated by or on behalf of an individual traveler or group of travelers who will make use of the above-mentioned items. The client subsystem 104 can, for example, be operated directly by the traveler(s), or by a travel agency on behalf of the traveler(s). The search parameters in the request 106 can include an origin location and a destination location for a flight (e.g., cities, specific airports, or the like), as well as time-based parameters such as a departure date and optionally, a return date. Various other search parameters can also be included in the request 106, such as a number of passengers, an identifier of the traveler (e.g., a name, account identifier, or other suitable identifier distinguishing the traveler from others), and the like.

As will be apparent to those skilled in the art, in the above example the supplier subsystems 116 are operated by supplier entities responsible for provision of the items, such as distinct airlines. The supplier subsystems 116 therefore each store and process data defining the items (e.g., seat availability, pricing rules, and additional related services for flights) provided by the corresponding operating entities.

The downstream processing initiated by the client subsystem 104 after receipt of the search results 120 can include, as will now be apparent, booking flight tickets (i.e., purchasing seats on a flight). In line with the characteristics of the requests 106 and results 120 mentioned above that complicate the handling of search requests, it may be difficult for the supplier subsystems 116 and/or the aggregator 108 to predict which flight(s) will be selected for purchase at the client subsystem 104. Similarly, it may also be difficult for the supplier subsystems 116 to predict which flights provided to the aggregator 108 will be selected for return to the client subsystem 104. The supplier subsystems 116 may therefore generate large numbers of search results, e.g., at different prices, with different associated services such as lounge access, extra baggage or the like, and/or with different combinations of flights between the origin and destination locations (e.g., whether via intermediate locations, or directly).

To mitigate the computational burden associated with generating and processing search results, the aggregator 108 is configured, as will be described in greater detail below, to enrich the message(s) in the data exchanges 118 that convey the parameters from the search request 106, prior to delivering such messages to selected supplier subsystems 116. In particular, the aggregator 108 is configured to access (e.g., from local storage, or via the network 112) a repository 124 of historical data containing previous search results generated in response to previous search requests, as well as previous sets 120 of search results from the aggregator 108. For a given supplier subsystem 116 selected to receive the current search request 106, the aggregator 108 is configured to select, from the repository 124, a subset of the previous search results generated by other supplier subsystems 116. In other words, the aggregator 108 is configured to enrich the data from the search request 106 with data extracted from search results from the repository 124 generated by competing supplier subsystems 116, prior to delivering the enriched data from the search request via a data exchange 118. The selection of previous search results is based on a correspondence between those previous search results and the current search request 106. In some examples, the selection of previous search results can also be based on the accuracy or relevance of the previous search results, as defined by indicators in the repository 124 of whether the previous search results were selected for return to the client subsystem 104, and/or selected at the client subsystem 104 for further processing.

The repository 124 (or one or more additional repositories accessible to the aggregator 108) can also, in some examples, contain profile data corresponding to either or both of the client subsystem 104 and the supplier subsystems 116. When such profile data is available, the aggregator 108 can be further configured to employ the profile data in selecting the previous search results. Having selected the previous search results, the aggregator 108 is configured to transmit auxiliary search parameters to the supplier subsystem 116 along with the parameters from the search request 106. The auxiliary search parameters are based on the selected previous search results and indicate, to the relevant supplier subsystem 116, likely characteristics of search results that competing supplier subsystems 116 may generate in response to the same search request 106. The supplier subsystem 116 can make use of the auxiliary search parameters to tailor the set of search responses it generates, e.g., to improve the likelihood of search results being selected for return instead of competing search results, and/or to improve the relevance of search results to the client device 104. Such improvements may further be attained with reduced computational expenditure in comparison to a scenario in which the auxiliary search parameters are not available, because the auxiliary search parameters may reduce the search space to be traversed by the result-generation mechanisms executed at the supplier subsystem 116. The reduction in search space can also facilitate near real-time delivery of search results back to the aggregator 108. The computational load associated with serving any given search request can therefore be reduced, without negatively affecting the quality of the results (or even, in at least some cases, while improving relevance).

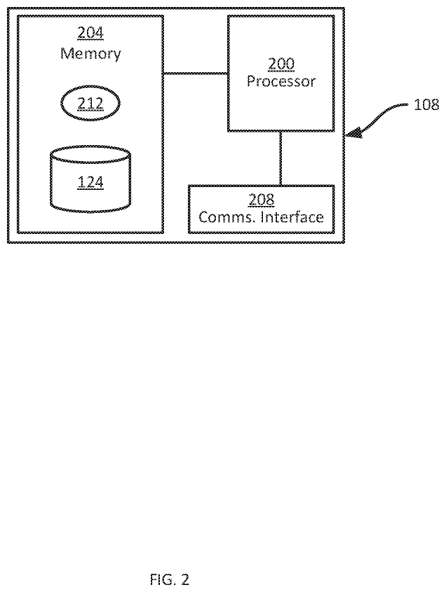

Before discussing the operation of the system 100 in greater detail, certain internal components of the aggregator 108 will be described with reference to FIG. 2.

The aggregator 108 includes at least one processor 200, such as a central processing unit (CPU), graphics processing unit (GPU), or suitable combination thereof. The processor 200 is interconnected with non-transitory computer-readable medium such as a memory 204 (e.g., a suitable combination of non-volatile and volatile memory subsystems including any one or more of Random Access Memory (RAM), read only memory (ROM), Electrically Erasable Programmable Read Only Memory (EEPROM), flash memory, magnetic computer storage, and the like). The processor 200 and the memory 204 are generally comprised of one or more integrated circuits (ICs).

The processor 200 is also interconnected with a communications interface 208, which enables the aggregator 108 to communicate with the other computing devices of the system 100 via the network 112. The communications interface 208 therefore includes any necessary components (e.g., network interface controllers (NICs), radio units, and the like) to communicate via the network 112. The specific components of the communications interface 208 are selected based on upon the nature of the network 112. The aggregator 108 can also include input and output devices connected to the processor 200, such as keyboards, mice, displays, and the like (not shown).

The components of the aggregator 108 mentioned above can be deployed in a single enclosure, or in a distributed format. In some examples, therefore, the aggregator 108 includes a plurality of processors, either sharing the memory 204 and communications interface 208, or each having distinct associated memories and communications interfaces.

The memory 204 stores a plurality of computer-readable programming instructions, executable by the processor 200. The instructions stored in the memory 204 include an application 212, execution of which by the processor 200 configures the aggregator 108 to perform various functions related to the handling of search requests, including the enrichment of such requests with data from the repository 124, as outlined above. In other examples, the functions implemented by the application 212 can be divided between more than one application and/or more than one computing device. For example, execution of a first application can implement the processes involved in receiving search requests, selecting supplier subsystems 116, sending search requests to the selected supplier subsystems 116, and evaluating the search results to select the results 120 for return to the client subsystem 104. A second application can implement the processes involved in enriching the search request prior to transmission (e.g., by the first application) to the supplier subsystems 116.

The memory 204 also stores the repository 124 in this example. As noted earlier, in other examples the repository 124 can be stored at a distinct computing device or other network-accessible storage device, rather than in local memory 204 at the aggregator 108.

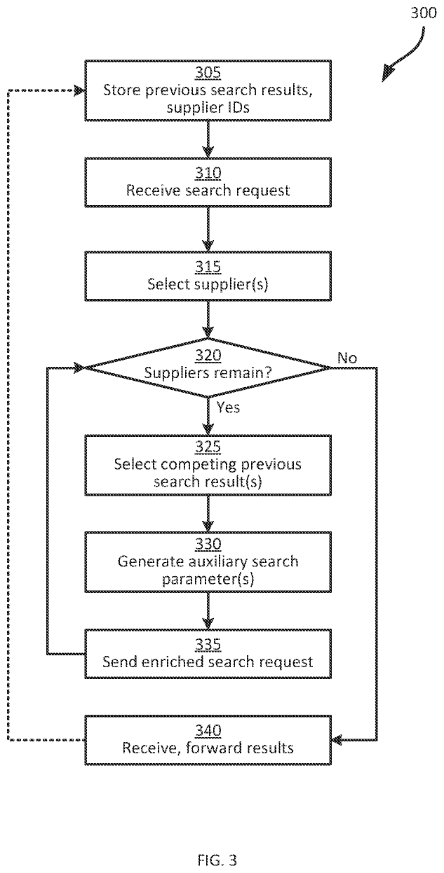

Turning to FIG. 3, a method 300 for predictive enrichment of search requests is illustrated. The method 300 will be described in conjunction with its example performance in the system 100. In particular, in the discussion below, the blocks of the method 300 are performed by the aggregator 108.

At block 305, the aggregator 108 is configured to store or otherwise access previous search results. In the illustrated example, the previous search results are stored at the aggregator 108, in the repository 124. The aggregator 108 can add previous search results to the repository 124, for example, in response to each search request 106 handled by the aggregator 108. For example, the aggregator 108 can be configured to store any search results received from the supplier subsystems 116, in response to any search request, regardless of whether those search results are selected by the aggregator 108 for transmission to the client subsystem 104.

The aggregator 108 also stores or otherwise accesses, e.g., via the repository 124, a supplier identifier for each previous search result, indicating which supplier subsystem 116 generated that previous search result. The repository 124 can also store metadata corresponding to each previous search result, including for example one or more timestamps indicating the time the previous search result was generated by the relevant supplier subsystem 116, and/or an indication of whether the previous search result was selected to be forwarded to the client subsystem in the set of results 120. The indication, also referred to as a previous handling indicator, can be binary (e.g., the value “yes” or “no”, “1” or “0”, or the like). In other examples, the previous handling indicator can be selected from more than two values, e.g., indicating whether the search result was discarded, forwarded to the client subsystem 104, or both forwarded and followed by a further request from the client subsystem 104, such as a booking and/or purchase request. Other values for the previous handling indicators may also occur to those skilled in the art, including scores defining previously assessed relevance of the search results. Such scores can be based on price, service levels, or the like.

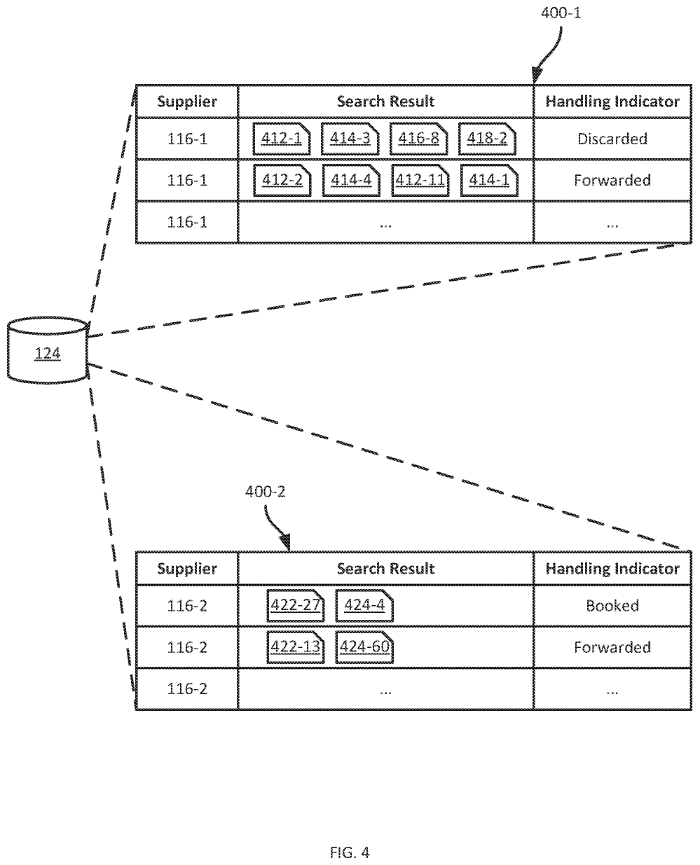

The repository 124, in other words, is a historical record of search results generated by the supplier subsystems 116, and optionally the outcomes associated with those search results. FIG. 4 illustrates example selected contents of the repository 124. For example, two portions 400-1 and 400-2 of the repository 124 are illustrated, each including a plurality of records. Each record (i.e., each row in the tables illustrated in FIG. 4) defines a previous search result, and contains an identifier (e.g., 116-1 or 116-2 in the example shown in FIG. 4) of the supplier subsystem 116 that generated the previous search result. As will be apparent, the portion 400-1 contains previous search results generated by the supplier subsystem 116-1, and the second portion 400-2 contains previous search results generated by the supplier subsystem 116-2. In the context of travel-related products and services, the previous search results are referred to as itineraries, e.g., each defining at least one flight and in some cases defining additional services such as hotel room reservations, and the like. The repository 124 can also include an indexing mechanism, enabling rapid retrieval of previous search results at various granularities (e.g., using different keys).

The “search result” portion of each record can be a single field, or a plurality of fields each containing a subset of the data defining a previous search result. The data defining a previous search result includes any of a wide variety of associated values, including values defining the products or services corresponding to the previous search result, as well as values defining the search context, such as the time and date the previous search result was generated, the identity of the client subsystem 104 whose request led to generation of the previous search result, attributes of that client subsystem 104 (e.g., the geographic location of the client subsystem 104, an account identifier corresponding to a traveler, or the like), the search parameters in the original search request, and the like.

In the illustrated example, the first record in the portion 400-1 contains a value or set of values 412-1 indicating origin and destination values (e.g., cities and/or airports), as well as a date and time of a flight between the origin and destination. The first record also includes a price value 414-3 corresponding to the origin and destination 412-1. The first record further includes an additional service value or values 416-8, e.g., corresponding to an extra bag check fee, as well as a service price 418-2 for the extra bag check. The second record in the portion 400-1 defines an itinerary including two flights, and thus includes first and second origin and destination values 412-2 and 412-11, as well as corresponding prices 414-4 and 414-1. In other words, each record in the repository 124 includes a plurality of values defining a previous search result and, in at least some cases, the search context that lead to that previous search result. The first record of the portion 400-2, for instance, contains further values 422-27 (defining an origin and destination pair) and 424-4 (defining a corresponding price), while the second record of the second portion 400-2 contains values 422-13 (defining an origin and destination pair) and 424-60 (defining a corresponding price).

As also shown in FIG. 4, in the illustrated example each record also contains a previous handling indicator distinguishing between three outcomes for each previous search result. In particular, each previous handling indicator indicates that the corresponding search result was either discarded at the aggregator 108 rather than being forwarded to the client subsystem 104 (“Discarded”), forwarded to the client subsystem 104 but not purchased (“Forwarded”), or forwarded to the client subsystem 104 and purchased (“Booked”).

Returning to FIG. 3, at block 310, the aggregator 108 is configured to receive a current search request from the client subsystem 104. The current search request includes a set of client search parameters, e.g., input by an operator at the client subsystem 104. In the context of the provision of travel items as noted earlier, the client search parameters can include origin and destination locations, and may also include a travel date or range of travel dates. The client search parameters can include a variety of additional values, but such additional values can also be omitted in some examples (i.e., these additional values are not mandatory). Examples of additional values are an indication of whether direct flights or multi-leg flights are preferred, a number of passengers, a return date, a class preference (e.g., economy, business class, or the like). In some examples, the client search parameters can include an account identifier or the like, distinguishing the client subsystem 104 from other client subsystems, or the operator thereof (e.g., the traveler seeking travel items) from other operators. As noted earlier, the repository 124 can also include profile data containing information specific to given travelers, such as account identifiers, locations of residence, travel preferences and the like. Various other client search parameters will also occur to those skilled in the art.

At block 315, the aggregator 108 is configured to select a set of the supplier subsystems 116 to which the current search request from block 310 will be passed for generation of search results. The selection at block 315 can be based, for example, on supplier profile data in the repository 124. For example, the supplier profile data can include, for each supplier subsystem 116, an indication of which geographic regions the operating entity of that supplier subsystem 116 is active in. Thus, if the origin and destination locations are outside the geographic region in the supplier profile, the corresponding supplier subsystem 116 is not selected at block 315.

Having selected a set of the supplier subsystems 116 (at least one supplier subsystem 116, up to all of the supplier subsystems 116) at block 315, at block 320 the aggregator 108 is configured to determine whether the current search request has been passed to all the selected supplier subsystems 116. The first performance of block 320 for any given instance of the method 300 is affirmative, as no selected supplier subsystems 116 have yet been processed. The performance of the method 300 therefore proceeds to block 325.

At block 325, the aggregator 108 selects an unprocessed one of the set of supplier subsystems 116 from block 315. The aggregator 108 then selects a subset of the previous search results contained in the repository 124 and generated by a different supplier subsystem 116. For example, following a selection of the supplier subsystems 116-1, 116-2, and 116-4 at block 315, the aggregator 108 is configured to select the supplier subsystem 116-1 at block 320, and to then select, at block 325, at least one previous search result generated by any of the supplier subsystems 116-2, 116-3, and 116-4. The selection of previous search results at block 325 is based at least on a correspondence between the search parameters in the current search request, and attributes of the previous search results in the repository 124. The selection can also be based on configuration data corresponding to the supplier subsystem 116-1, and/or on the previous handling indicators associated with the previous search results.

In some examples, prior to selecting previous search results at block 325, the aggregator 108 can be configured to determine whether the current supplier subsystem 116 is enrolled for receipt of enriched search requests. For example, the repository 124 can include a set of auxiliary enrollment identifiers corresponding to supplier subsystems 116 that are subscribed to the search request enrichment functionality implemented by the aggregator 108.

That is, in general, at block 325 the aggregator 108 selects previous search results that, although generated for distinct search requests from the current search request, are nevertheless representative of search results that, for the current search request, are likely to be generated by competing supplier subsystems 116. The previous search results selected at block 325, in other words, represent the search results against which those generated by the supplier subsystem 116-1 will compete to be forwarded by the aggregator 108, and/or selected for booking by the client subsystem 104.

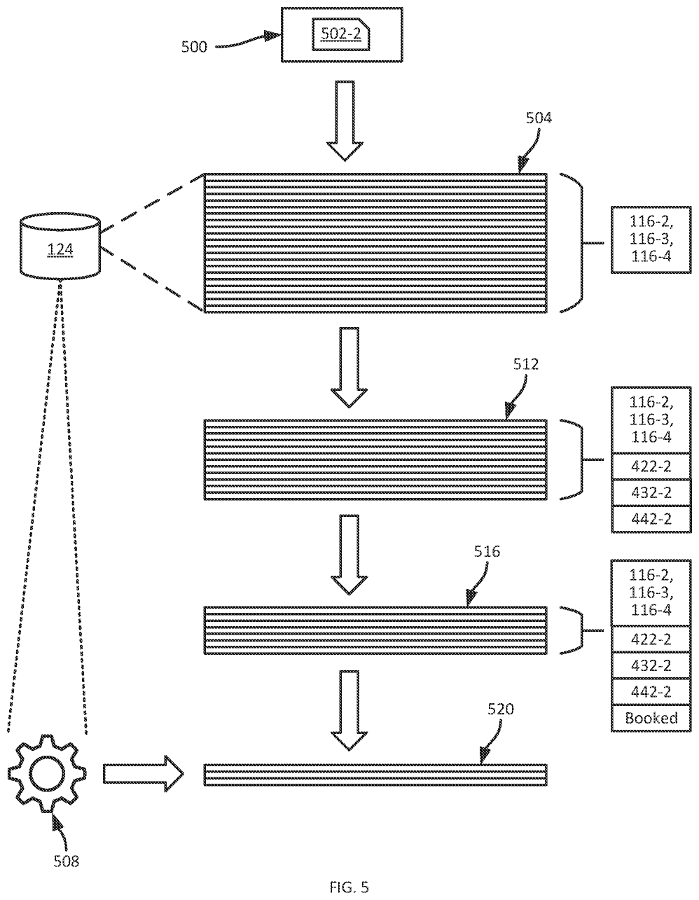

Various mechanisms for selecting previous search results at block 325 are contemplated. In some examples, referring to FIG. 5, the aggregator 108 can be configured to implement a filtering process to select previous search results that match at least a portion of the search parameters in the current search request. Specifically, as shown in FIG. 5, the aggregator 108 receives a current search request 500 containing a search parameter 502-2. The search parameter is an origin-destination pair, for example specifying an origin location “YYZ” (i.e., the IATA code for Toronto Pearson International Airport) and a destination location “KEF” (i.e., the IATA code for Keflavik International Airport). The request 500 can contain various other search parameters, in other examples.

Following the previous example, in which the supplier subsystems 116-1, 116-2, and 116-4 are selected at block 315, and the supplier subsystem 116-1 is selected for processing at block 320, at block 325 the aggregator 108 can be configured to first retrieve a set 504 of previous search results in the form of itineraries previously generated by the supplier subsystems 116-2, 116-3, and 116-4 (i.e., suppliers other than the subsystem 116-1) from the repository 124 (e.g., irrespective of locations or other attributes). In some examples, the first filtering step can omit certain other supplier subsystems 116. For example, configuration data 508 can include profile data for the supplier subsystem 116-1 indicating, among other information, identifiers of competing supplier subsystems 116 to be excluded from the selection at block 625, and/or included in the selection at block 625. For example, a given airline may elect to exclude previous search results generated by a discount carrier from selection at block 325, e.g., if the airline does not intend to compete on price with the discount carrier.

From the set 504, the aggregator 108 can be configured to then select a subset 512 of the previous search results with the same origin-destination pair. That is, the aggregator 108 can be configured to select previous search results with values 422-2 (indicating an origin and destination pair generated by the supplier subsystem 116-2 matching the value 502-2), 432-2, or 442-2 (matching values generated by the supplier subsystems 116-3 and 116-4, respectively). The aggregator 108 can also select previous search results with multiple origin and destination values that “sum” to the value 502-2 (e.g., a first value indicating a flight from YYZ to London Heathrow, and a second value indicating a flight from Heathrow to KEF).

From the subset 512, the aggregator 108 can then be configured to select a further subset 516 of previous search results not only generated by the supplier subsystems 116-2, 116-3, or 116-4 for the same origin and destination locations, but also having certain previous handling indicators. In the illustrated example, the subset 516 consists of the search results from the subset 512 with the previous handling indicator “Booked”. In other examples, the subset 516 need not be limited to booked previous search results, but can instead include any search results with the handling indicators “Forwarded” or “Booked”.

As will now be apparent, further layers of filtering can be applied. For example, as shown in FIG. 5, the aggregator 108 can be configured to select a further subset 520 from the subset 516, consisting of a predefined number of previous search results (e.g., three, in this example) in the subset 520. The predefined number itself can be defined in the configuration data 508, as can the criteria for selecting the predefined number. For example, the configuration data 508 can specify that the three previous search results with the lowest prices (regardless of supplier subsystem 116) are to be selected for the subset 520. In other examples, the configuration data can specify that the lowest-priced previous search result from each other supplier subsystem 116 is to be selected for the subset 520. Other layers of selection can include by client identifier, e.g., if a client identifier is available for the current search request, and if client identifiers are available for the previous search results.

A further example criterion applied in the filtering process described above include an age threshold, e.g., specified in the configuration data 508. The age threshold can specify, for example, a maximum age threshold for selected previous search results. Thus, any previous search results in the repository 124 older than the age threshold are omitted from selection at block 325. In further examples, the configuration data 508 can define a prioritized attribute for previous search results. For example, the configuration data 508 can prioritize the selection of previous search results with the maximum price.

Thus, via the performance of block 325 as illustrated in FIG. 5, three previous search results are identified that were generated by supplier subsystems 116 other than the supplier subsystem 116-1 from which the request 500 was received, with origin and destination locations matching those of the current search request 500, and (in this example) that were sufficiently relevant to be not only forwarded to the client subsystem 104 (rather than being discarded), but also to be booked by the client subsystem 104. Returning to FIG. 3, at block 330 the aggregator 108 is configured to generate auxiliary search parameters based on the subset selected at block 325.

The auxiliary search parameters can include the previous search results selected at block 325 themselves. In other examples, the auxiliary search parameters include metadata including an aggregated attribute derived from the previous search results selected at block 325. For example, at block 330 the aggregator 108 can be configured to determine an average price of the subset of previous search results selected at block 325, thus reducing the volume of data employed to represent the selected previous search results.

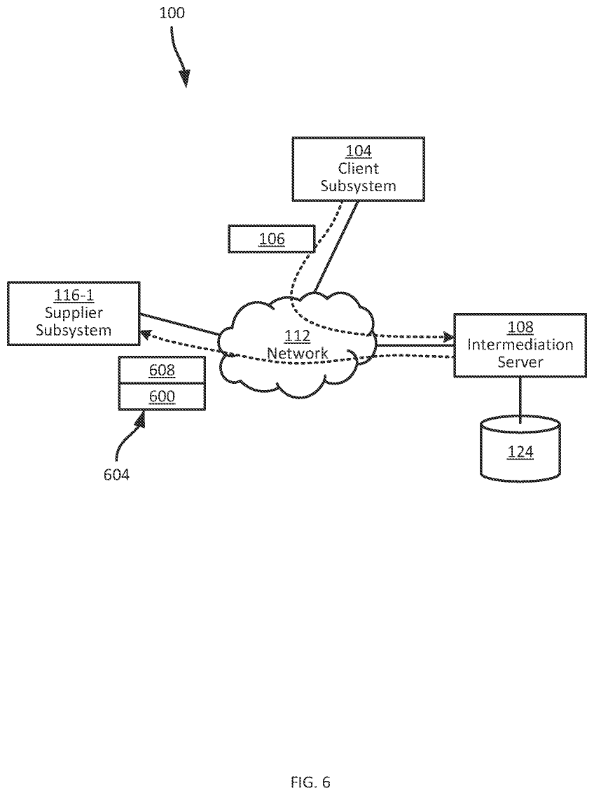

At block 335, the aggregator 108 is configured to send the search request from block 310, as well as the auxiliary search parameters from block 330 (together referred to as an enriched search request), to the relevant supplier subsystem 116. Turning to FIG. 6, an example performance of block 335 is illustrated, in which a search request 106 received at the aggregator 108 is enriched with auxiliary search parameters 600 including or derived from previous search results selected at block 325. A message 604 (also referred to as an enriched search request) sent to the supplier subsystem 116-1 can therefore include, for example, search parameters 608 and/or other information derived from the search request 106, as well as the auxiliary search parameters 600. The auxiliary search parameters 600 can be included, for example, in a field of the message 604. For example, the search parameters 608 (that is, the base search parameters extracted or derived from the search request 106) can be conveyed to the supplier subsystem 116-1 in a New Distribution Capability (NDC)-formatted message. The auxiliary search parameters 600 can be included in an existing field of the NDC-formatted message (e.g., the Offer Details field), such that little or no modification is required to the message-handling logic at the supplier subsystem 116-1.

Returning to FIG. 3, following transmission of the enriched search request at block 335, the aggregator 108 returns to block 320 to determine whether further supplier subsystems 116 selected at block 315 remain to be processed. In some examples, enriched search requests can be sent substantially simultaneously after all supplier subsystems 116 have been processed, such that the aggregator 108 can return to block 320 from block 330 rather than from block 335.

When the determination at block 320 is negative, indicating that an enriched search request has been generated for each selected supplier subsystem 116 from block 315, the aggregator 108 proceeds to block 340. At block 340, the aggregator 108 is configured to receive search results (or, in some cases, messages indicating that no search results have been generated) from the supplier subsystems 116 to which enriched search requests were sent. The aggregator 108 is further configured, as noted earlier, to select a subset of the received search results for forwarding to the client subsystem 104. In addition, all received search results can be stored in the repository 124 along with handling indicators, as indicated by the dashed line returning from block 340 to block 305, for use in subsequent performances of the method 300.

The aggregator 108 receives, from the supplier subsystem 116, the current search results generated at the supplier subsystem 116; and returns the current search results to the client subsystem 104 in response to the search request.

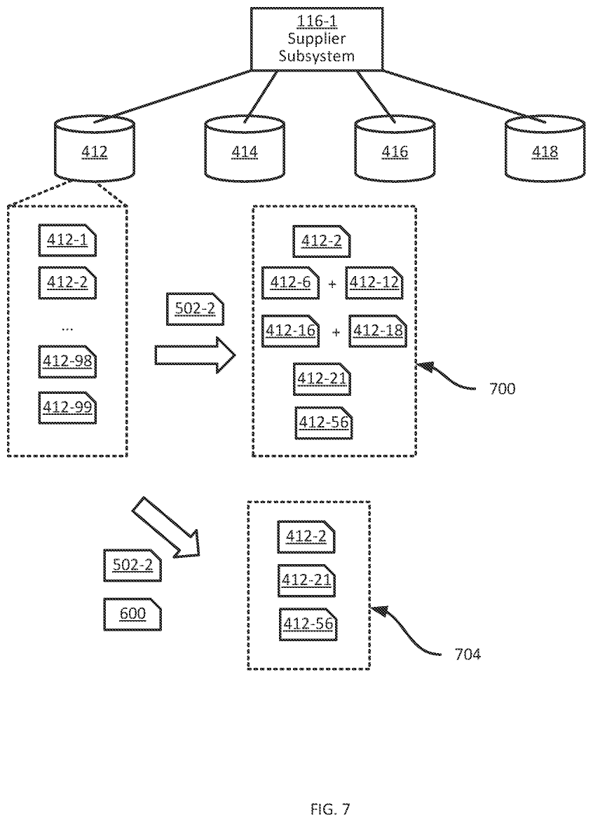

The specific manner in which the enriched search request sent at block 335 is used by the relevant supplier subsystem 116 to generate current search results can vary widely. However, it will be apparent to those skilled in the art that the auxiliary search parameters can be employed at the supplier subsystems 116 to reduce the search space traversed in generating search results. For example, turning to FIG. 7, the supplier subsystem 116-1 may store or otherwise access a set of repositories 412, 414, 416, and 418, containing values such as those discussed earlier in connection with FIG. 4. For example, the repository 412 may contain origin and destination pairs, along with flight dates and times. The repository 414 may contain prices (e.g., defined as specific values or as various sets of pricing rules to be applied to flights) that can be applied to the flights defined in the repository 412. The repository 416 can contain values defining additional services, and the repository 418 can contain prices to be applied to the additional services.

The repository 412 may contain a large number of values 412-1, 412-2, and so on (e.g., up to 412-98 and 412-99, although the repository 412 can also contain a significantly greater number of values. Upon receiving a search request with a given origin and destination value such as the value 502-2 mentioned earlier, the supplier subsystem 116 can retrieve from the repository 412 a set of candidate values 700 matching the requested origin and destination. The candidate values 700 may include individual flight legs matching the value 502-2 (e.g., the values 412-2, 412-21, and 412-56), as well as combinations of flights that match the value 502-2 (e.g., the values 412-6 and 412-12, and the values 412-16 and 412-18).

When the search request also includes auxiliary search parameters 600, e.g., containing previous search results that define direct flights only, the supplier subsystem 116-1 may instead select only direct flights, thus eliminating the pairs of values shown in the set 700. The supplier subsystem 116-1 can instead select a set 704 containing only direct flights. The set 704 being smaller than the set 700 leads to fewer combinations of flights and pricing rules (from the repository 414), as well as fewer combinations of flights with additional services and corresponding prices from the repositories 416 and 418. The supplier subsystem 116-1 can, in other words, leverage the auxiliary search parameters 600 to reduce the computational load involved in generating search results. The auxiliary search parameters 600 can also limit search space in a variety of other ways. For example, the supplier subsystem 116-1 may limit the search space within the price repository 414, e.g., by eliminating from consideration any pricing data that is uncompetitive with competing pricing data represented in the auxiliary search parameters 600. In further examples, the supplier subsystem 116-1 may limit the search space by eliminating the services repository 416 from consideration, e.g., when the auxiliary search parameters 600 indicate that competing supplier subsystems 116 are unlikely to generate offers including bundled services.

Other mechanisms for performing the selection of previous search results at block 325 are also contemplated. For example, the aggregator 108 can implement a machine learning module to perform the selection of previous search results. The machine learning module can be trained, for example, to predict the relevance of various stored previous search results to the current search request (i.e. to a search request distinct from the search requests that yielded the previous search results) and to the configuration of the relevant supplier 116.

The machine learning module comprises machine learning algorithms or self-learning algorithms that can be realized by systems known in the state-of-the-art, such as artificial neural networks, support vector machines, Bayesian networks and genetic algorithms using approaches such as supervised, semi-supervised or unsupervised learning, or approaches such as reinforcement learning, feature learning, spare dictionary learning, anomaly detection, decision tree learning association rule learning etc.

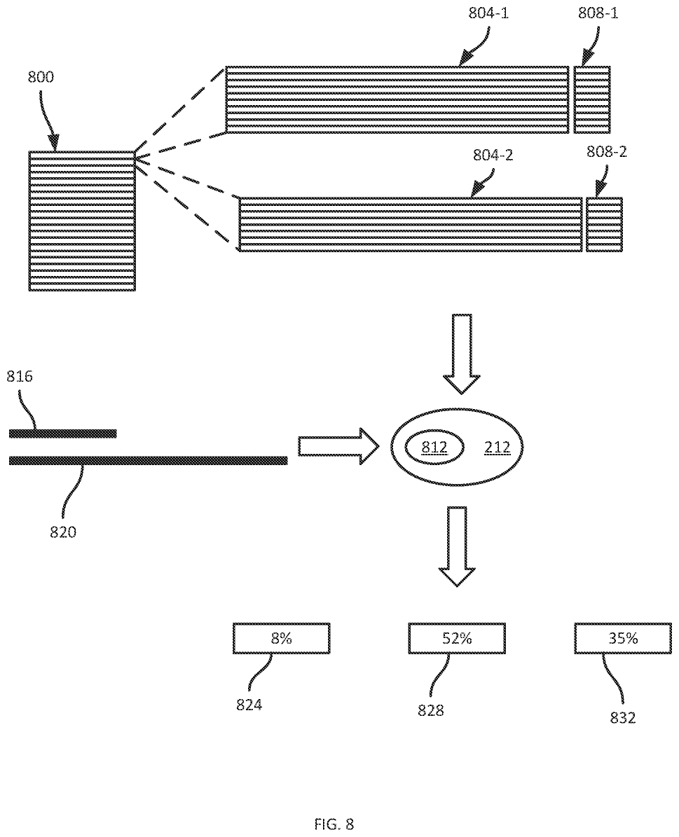

Turning to FIG. 8, an example generation and operational process for such a module is illustrated. To train the model, for example, a set of previous search requests 800, as well as corresponding previous search results 804 can be retrieved. For example, one previous search request yielded the previous search results 804-1 (ten records, in this example), with corresponding handling indicators 808-1, while another previous search request yielded the previous search results 804-2 (eight records, in the illustrated example), with corresponding handling indicators 808-2.

The model can be trained by, for example, providing a plurality of labelled inputs, each consisting of a previous search request and a previous search result corresponding to that search request. Thus, the two previous search requests mentioned above may yield a total of eighteen sets of inputs to the training process. The labels for these inputs consist of the corresponding handling indicators 808. The training process therefore leads to the generation of model parameters 812 (e.g., stored within the application 212) that enable the application 212 to predict, for any given input consisting of a current search request and a previous search result, a likelihood that the previous search result would be relevant to the current search request. The training process can also include labelling the previous search results 804 based on the relevance of the suppliers 116 that generated the previous search results 804 to a supplier 116 corresponding to the model 812. That is, the aggregator 108 can maintain distinct models 812 for each supplier 116, each trained based not only on previous search requests and results, but also on supplier configuration data such as that mentioned earlier in connection with FIG. 5.

For example, input data including a current search request 816 and a previous search result 820 (e.g., from the subset 512 or 516 mentioned earlier) can be provided to the trained model 812, to generate probabilities that the previous search result 820 would lead to each of the available handling indicators. For example, the output of the model 812 may indicate that the previous search result 820 has a probability 824 of 8% of being discarded at the aggregator 108, a probability 828 of 52% of being forwarded to the client subsystem 104, and a probability 832 of 35% of being booked at the client subsystem 104. At block 325, the aggregator 108 can therefore be configured to select, for example, the three (or any other suitable number) previous search results with the highest probabilities of being forwarded and/or booked.

As will now be apparent, the provision of enriched search requests to the supplier subsystems 116 enables the supplier subsystems 116 to reduce the volume of search results generated and returned to the aggregator 108. For example, as noted in connection with FIG. 7, if each previous search result provided to the supplier subsystem 116-1 with a search request defines a direct flight, the supplier subsystem 116-1 may omit the generation of any search results that are not direct flights. The availability of the auxiliary search parameters, in other words, may reduce the search space to be traversed at the supplier subsystem 116, leading to a corresponding reduction in computational resources expended in generating search results. Conversely, if substantially the same computational resources are expended in generating search results for a given request at a supplier subsystem 116, a greater proportion of those search results is likely to be forwarded to the client subsystem 104 for potential purchase. The commercial return generated for those computational resources may therefore be increased, effectively reducing the computational resources committed to a given amount of return. In other words, the suppliers 116 may generate search results with greater relevance to the search request 106, potentially improving conversion rates (e.g., offers that lead to bookings). The suppliers 116 may also employ the auxiliary search parameters 600 to update and/or enrich revenue management systems.

The aggregator 108 may therefore also be required to process smaller numbers of search results from the supplier subsystems 116, and/or may be required to discard fewer results. As will be apparent, the degree of reduction in computational load at the aggregator 108 may increase for each supplier subsystem 116 making use of the auxiliary search parameters.

The scope of the claims should not be limited by the embodiments set forth in the above examples, but should be given the broadest interpretation consistent with the description as a whole.

1. A method, comprising:
at an aggregator, storing a repository containing:
(i) a plurality of previous search results generated by supplier subsystems, in response to previous search requests received at the supplier subsystems, and
(ii) for each previous search result, a supplier identifier of the supplier subsystem having generated the previous search result;
receiving a current search request containing current search parameters at the aggregator;
responsive to receiving the current search request, selecting, at the aggregator, a set of the supplier subsystems for search result generation;
for a first supplier subsystem from the set, retrieving a previous search result associated in the repository with a second supplier subsystem from the set, based on correspondence between (i) the search parameters and (ii) attributes of the previous search results; and
sending, from the aggregator to the first supplier subsystem, (i) the current search request, and (ii) auxiliary search parameters corresponding to the retrieved previous search result, for generation of current search results at the first provider subsystem employing the auxiliary search parameters as inputs.

2. The method of claim 1, further comprising: sending the current search request from the aggregator to each remaining supplier subsystem from the set, including the second supplier subsystem.

3. The method of claim 1, further comprising:
storing, in the repository, auxiliary enrollment identifiers corresponding to at least a subset of the supplier subsystems; and
identifying the first supplier subsystem according to the auxiliary enrollment identifiers.

4. The method of claim 1, further comprising:
storing, for each previous search result, a previous handling indicator defining whether the previous search result was returned from the aggregator to a client subsystem;
wherein retrieving the previous search result is further based on the previous handling indicators.

5. The method of claim 1, wherein the auxiliary search parameters include the identifier of the second supplier subsystem.

6. The method of claim 5, wherein the auxiliary search parameters include at least one of (i) a price of the previous search result, and (ii) an identifier of an associated service and a price of the associated service.

7. The method of claim 1, further comprising:
storing, in the repository, configuration settings defining an age threshold for previous search results;
wherein retrieving the previous search result omits previous search results having ages greater than the age threshold.

8. The method of claim 7, wherein the configuration settings further include, for the first supplier subsystem, a prioritized search result attribute; and
wherein retrieving the previous search result is further based on the prioritized search result attribute.

9. The method of claim 1, wherein providing the search request includes transmitting a New Distribution Capability (NDC)-formatted message to the provider subsystem, wherein the auxiliary search parameters are contained in a field of the NDC-formatted message.

10. The method of claim 1, wherein retrieving the previous search result associated with the second supplier subsystem includes:
selecting candidate previous search results associated with the second supplier subsystem;
providing the candidate previous search results and the search parameters to a classifier, to obtain a relevance indicator for each of the candidate previous search results; and
selecting the previous search result by comparing the relevance indicators to a threshold.

11. A computing device, comprising:
a memory storing a repository containing:
(i) a plurality of previous search results generated by supplier subsystems, in response to previous search requests received at the supplier subsystems, and
(ii) for each previous search result, a supplier identifier of the supplier subsystem having generated the previous search result; and
a processor configured to:
receive a current search request containing current search parameters at the aggregator;
responsive to receiving the current search request, select a set of the supplier subsystems for search result generation;
for a first supplier subsystem from the set, retrieve a previous search result associated in the repository with a second supplier subsystem from the set, based on correspondence between (i) the search parameters and (ii) attributes of the previous search results; and
send, to the first supplier subsystem, (i) the current search request, and (ii) auxiliary search parameters corresponding to the retrieved previous search result, for generation of current search results at the first provider subsystem employing the auxiliary search parameters as inputs.

12. The computing device of claim 11, wherein the processor is further configured to:
send the current search request from the aggregator to each remaining supplier subsystem from the set, including the second supplier subsystem.

13. The computing device of claim 11, wherein the processor is further configured to:
store, in the repository, auxiliary enrollment identifiers corresponding to at least a subset of the supplier subsystems; and
identify the first supplier subsystem according to the auxiliary enrollment identifiers.

14. The computing device of claim 11, wherein the processor is further configured to:
store, for each previous search result, a previous handling indicator defining whether the previous search result was returned from the aggregator to a client subsystem; and
retrieve the previous search result based on the previous handling indicators.

15. The computing device of claim 11, wherein the auxiliary search parameters include the identifier of the second supplier subsystem.

16. The computing device of claim 15, wherein the auxiliary search parameters include at least one of (i) a price of the previous search result, and (ii) an identifier of an associated service and a price of the associated service.

17. The computing device of claim 11, wherein the processor is further configured to:
store, in the repository, configuration settings defining an age threshold for previous search results; and
retrieve the previous search result omitting previous search results having ages greater than the age threshold.

18. The computing device of claim 17, wherein the configuration settings further include, for the first supplier subsystem, a prioritized search result attribute; and
wherein the processor is configured to retrieve the previous search result based on the prioritized search result attribute.

19. The computing device of claim 11, wherein the processor is further configured to provide the search request by transmitting a New Distribution Capability (NDC)-formatted message to the provider subsystem, wherein the auxiliary search parameters are contained in a field of the NDC-formatted message.

20. The computing device of claim 11, wherein the processor is further configured to retrieve the previous search result associated with the second supplier subsystem by:
selecting candidate previous search results associated with the second supplier subsystem;
providing the candidate previous search results and the search parameters to a classifier, to obtain a relevance indicator for each of the candidate previous search results; and
selecting the previous search result by comparing the relevance indicators to a threshold.
